(19) United States
(12) Patent Application Publication
(10) Pub. No.: US 2024/0106110 A1
(43) Pub. Date: Mar. 28, 2024

(54) HOUSING SYSTEM FOR AIRCRAFT MOUNTED COMPONENTS

(71) Applicant: CAMTRONICS, LLC, Tulsa, OK (US)

(72) Inventor: David E. Campbell, Jenks, OK (US)

(73) Assignee: CAMTRONICS, LLC, Tulsa, OK (US)

(21) Appl. No.: 18/371,039

(22) Filed: Sep. 21, 2023

Related U.S. Application Data
(60) Provisional application No. 63/409,937, filed on Sep. 26, 2022.

(51) Int. Cl. H01Q 1/42; G08G 5/00

(52) U.S. Cl. CPC H01Q 1/421; G08G 5/0021; G08G 5/0078

(57) ABSTRACT

A traffic collision avoidance system (TCAS) device Configured to reduce or prevent the infiltration of water and other environmental contaminants into the interior of the TCAS device. The device having a radome attached to the ground plane so that the interior surface of the radome and the inner surface of the ground plane form an inner chamber. The inner surface of the ground plane has a PCB channel wall defining a center well facing the inner chamber and configured to receive a printed circuit board (PCB).

### CROSS-REFERENCE TO RELATED APPLICATION

This application claims the benefit of U.S. Provisional Application No. 63/409,937 filed Sep. 26, 2022, which is incorporated by reference.

### FIELD

The present disclosure relates generally to a housing for mounting components to an exterior of an aircraft, and in particular to a housing system for traffic collision avoidance system (TCAS) type devices.

### BACKGROUND

Aircraft have various externally-mounted systems. For example, various communication, aviation location and aircraft avoidance systems are utilized in aircraft. These systems may utilize antenna systems in a housing so as to protect the antenna systems from environmental hazards such as wind and water.

For example, one such system is a traffic collision avoidance) system (TCAS). In areas of congested airspace or low visibility, it is desirable for a pilot of one aircraft to be warned of the presence of a nearby aircraft so the respective aircraft may maneuver the aircraft to avoid collision. A traffic collision avoidance system (TCAS) employs a transponder mounted on the aircraft that communicates with transponders on nearby aircraft. In this way, the aircraft control systems automatically communicate and provide the pilots with appropriate and timely information about nearby aircraft.

TCAS devices are typically mounted on the external surface of the aircraft. For example, a commercial aircraft may have two TCAS devices, one mounted on the underside of the aircraft and one mounted on the top side in an area adjacent to the cockpit. The TCAS device has three major components, a ground plane, a radome, and an antenna assembly. Bonding material can be applied about the periphery of the ground plane to couple the radome to the ground plane and seal the antenna assembly from the external environment.

Since the TCAS devices are mounted on the outside of the aircraft, the devices need to operate over a wide environmental temperature range, typically on the order of −67° F. to 158° F. (−55 C to 70 C). This wide range of operating temperatures places a great deal of stress on the components of the TCAS device. In particular, the bonding layer between the ground plane and the radome is subjected to stresses due to the disparity between the coefficients of thermal expansion of the chassis and the radome. Repeated thermal cycling of the TCAS device may then result in a breach in the bonding layer allowing water, rain, de-icing fluids, and other fluids to migrate into the interior portion of the TCAS device. The entry of the condensation may then result in corrosion of the ground plane and antenna assembly, or generally result in malfunction of the antenna assembly.

While existing TCAS devices are suitable for their intended purposes, there remains a need for improvements. In particular, there remains a need for improvements in reducing or preventing the infiltration of water and other environmental contaminants into the interior of the TCAS device.

### SUMMARY

This disclosure relates generally to a housing for mounting components to the exterior of an aircraft. Generally, the housing comprises a radome and a ground plane. The radome having an interior surface and an exterior surface, and ground plane having an inner surface and an outer surface. The radome is attached to the ground plane so that the interior surface of the radome and the inner surface of the ground plane form an inner chamber. The inner surface of the ground plane has a PCB channel wall defining a center well facing the inner chamber and configured to receive a printed circuit board (PCB). The PCB channel wall blocks flow of liquids (water, de-icing fluids, and similar fluids) along the inner surface of the ground plane so as to prevent such liquids and/or fluids from entering the center well. Typically, the PCB channel wall is continuous around the center well. Additionally, the ground plane can further comprise a plurality of additional channel walls, which along with the PCB channel wall form a plurality of channels on the inner surface to direct flow of liquids and/or fluids along the inner surface of the ground plane.

In a more specific embodiment, the disclosure relates to a traffic collision avoidance system (TCAS) device. The device comprising a housing, an antenna assembly and at least one connector.

In this TCAS device, the housing is generally as described above. In this embodiment as well as others, the ground plane can additionally define at least one aperture within the center well. The aperture extending from the inner surface to the outer surface.

The antenna assembly is contained within the inner chamber of the housing, and has at least one antenna, a printed circuit board operatively connected to the antenna. The printed circuit board is positioned in the center well. The connector is positioned within at least one aperture so that the connectors can transmit hard-wired signals between the antenna assembly within the housing and outside the housing.

### BRIEF DESCRIPTION OF THE DRAWINGS

The foregoing summary as well as the following detailed description will refer to and be better understood when reviewed in conjunction with the appended figures. It should be understood that the invention is not limited to the precise arrangements and instrumentalities shown. Further, the components in the drawing(s) are not necessarily to scale, emphasis instead is placed upon clearly illustrating the principles of the present invention. Moreover, in the drawings, like reference numerals designate corresponding parts throughout the several views. In the drawings:

FIG. 1 is an illustration of a housing according to embodiments of this disclosure installed on an aircraft;

FIG. 2 is an exploded view of a TCAS device in accordance with the current disclosure;

FIG. 3. is a picture of a radome portion of a housing in accordance with this disclosure;

FIGS. 4-9 illustrate a ground plane in accordance with embodiments of this disclosure.

FIG. 10 illustrates the placement of the PCB and connectors in the ground plane.

FIG. 11 further illustrates the placement of the connectors.

### DETAILED DISCLOSURE

Numerous specific details are set forth in order to provide a thorough understanding of the embodiments described herein. However, those of ordinary skill in the art will understand that the embodiments described herein can be practiced without these specific details. In other instances, methods, procedures and components have not been described in detail so as not to obscure the related relevant feature being described.

This disclosure is directed generally to a housing for mounting components to the exterior of an aircraft. Such housings are used for a variety of purposes but generally for ones where an apparatus needs to be outside any shielding of electromagnetic radiation provided by the body of the aircraft but needs protection from the elements such as provided by a radome structure. A radome being a weatherproof enclosure that protects an electromagnetic antenna. The radome is constructed of material transparent to electromagnetic waves at least at electromagnetic frequencies used by the antenna. While generally described in terms of a traffic collision avoidance system (TCAS) used on aircrafts, the housing may be used with a wide variety of electromagnetic antenna systems such as a wide-angle augmentation system (WAAS), a European geostationary navigation overlay service (EGNOS), a multi-functional satellite augmentation system (MSAS), or other type of navigation augmentation system for aircraft.

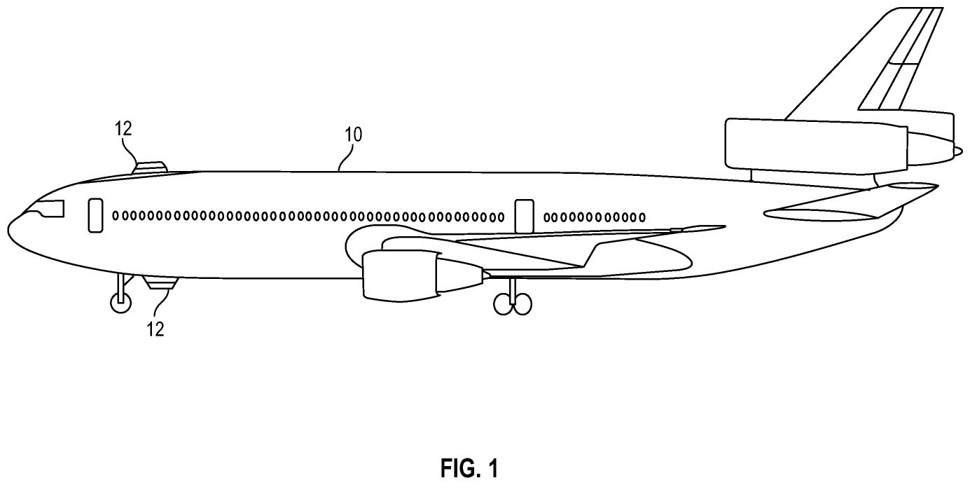

As illustrated in FIG. 1, these systems are typically mounted on the exterior of an aircraft. In the illustrated embodiment, the device 12 may be installed on an aircraft 10 at one or more locations such as on the top or the bottom of the fuselage of the aircraft 10 or other areas that are not shielded from radar interrogation.

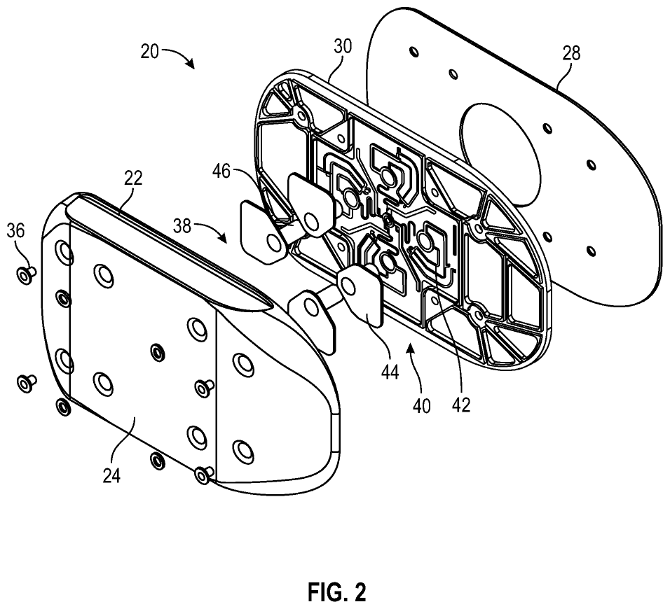

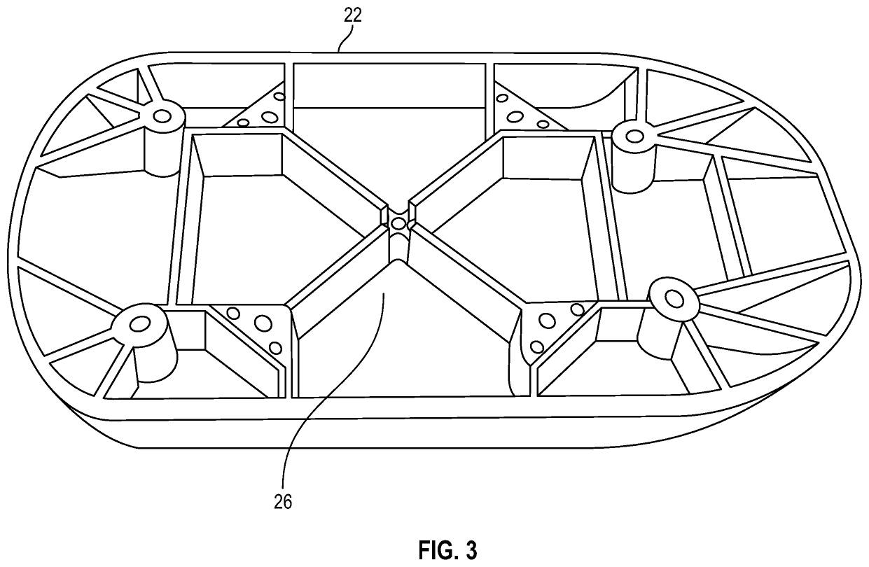

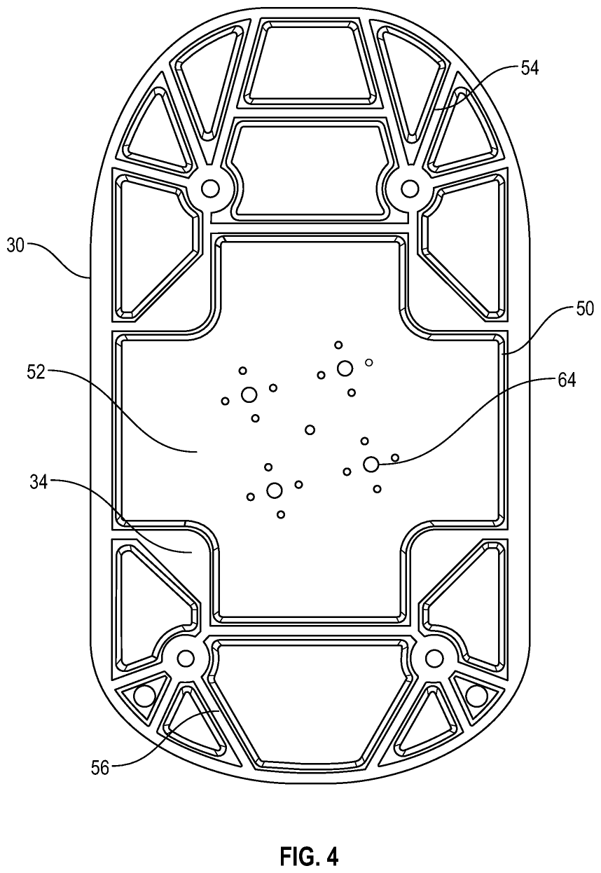

Turning now to FIG. 2, an exemplary TCAS device is shown in exploded view. The illustrated TCAS device incorporates features of the present disclosure. The TCAS device 20 includes a radome 22 mounted or attached to a ground plane 30. As indicated above radome 22 is constructed of material transparent to electromagnetic waves at least at electromagnetic frequencies used by the antenna. For example, radome 22 may be made from polymer materials such as polyethersulfone (PES) cover layer with urethane foam body. Radome 22 has an exterior surface 24 and an interior surface 26 (see FIG. 3.)

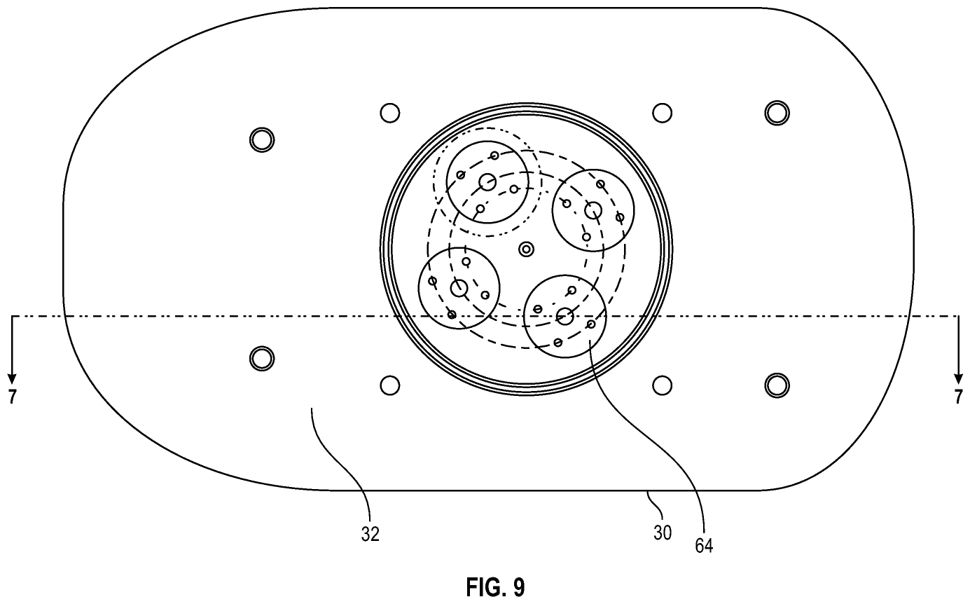

Generally, ground plane 30 (sometimes referred to as a chassis or a plate) is made of a conductive material so as to perform the grounding function. For example, the ground plane 30 can be made from an aircraft grade aluminum alloy, such as 6061 for example. Ground plane 30 has an outer surface 32 (see FIG. 9) and inner surface 34.

Radome 22 can be attached to ground plane 30 by any suitable means such as rivets or bolts 36. Conventionally, a bonding material can be applied about the periphery of the ground plane 30 to couple the radome 22 to the ground plane 30 and seal the antenna assembly from the external environment. For the current device, such bonding serves as a primary means of preventing liquids (including moisture/water, de-icing fluids, and similar fluids) from entering the housing and adversely affecting the components of the device; however, as discussed above, over time this primary means can develop leaks allowing liquids into the housing.

When radome 22 is mounted on ground plane 30, interior surface 26 of radome 22 and inner surface 34 of ground plane 30 form an interior chamber, shown roughly as area 38 in the exploded view of FIG. 2; though when radome 22 is mounted on ground plane 30, chamber 38 is completely enclosed by the interior surface 26 and inner surface 34.

An antenna assembly 40 is positioned within chamber 38. Antenna assembly 40 typically includes a printed circuit board (PCB) 42 and one or more antenna 44 that are separated from PCB 42 by standoffs 46. PCB 42 is located on ground plane 30, as further described below. The mounting can be by bonding, mounting screws or other suitable securing means.

Additionally, when device 20 is attached to an aircraft, a gasket 28 can be utilized between ground plane 30 and the aircraft surface.

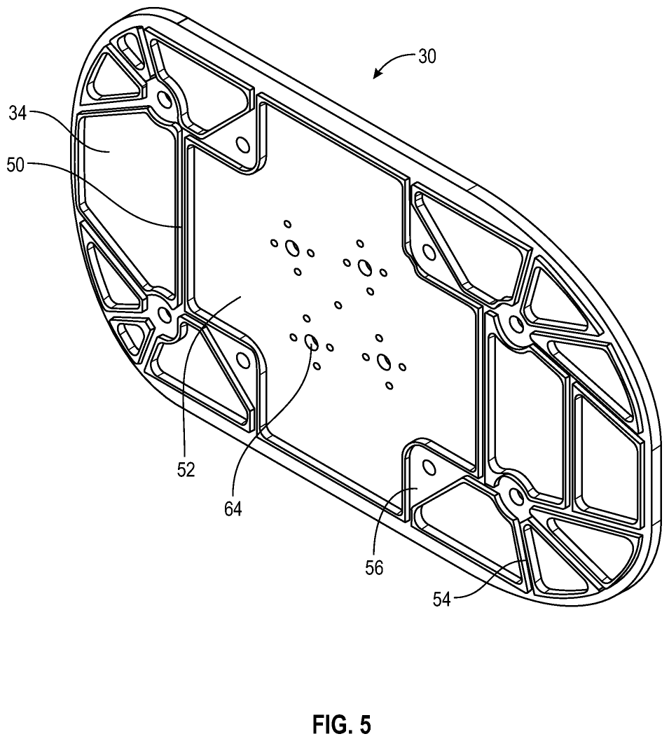

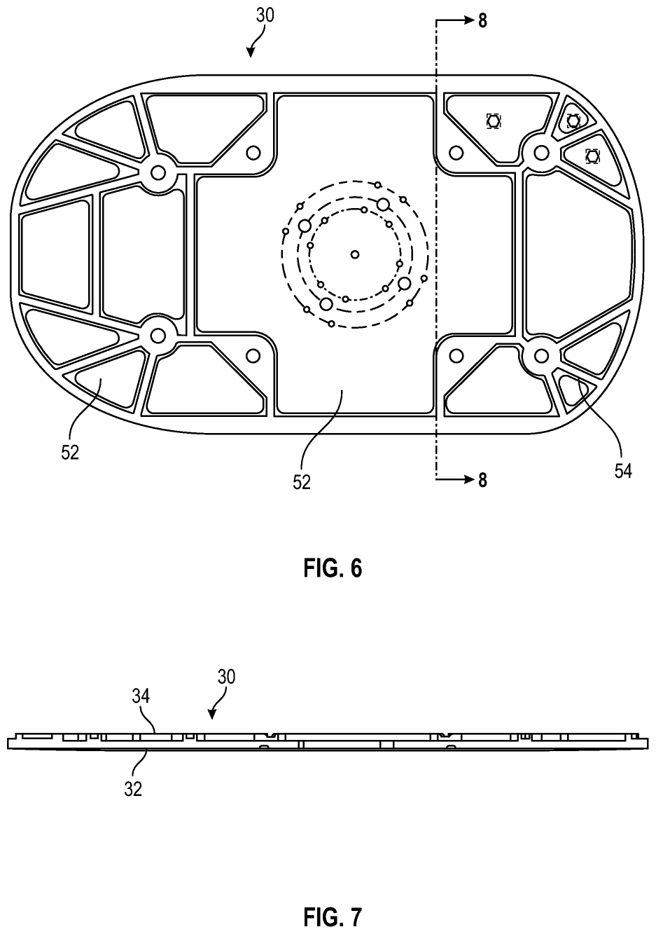

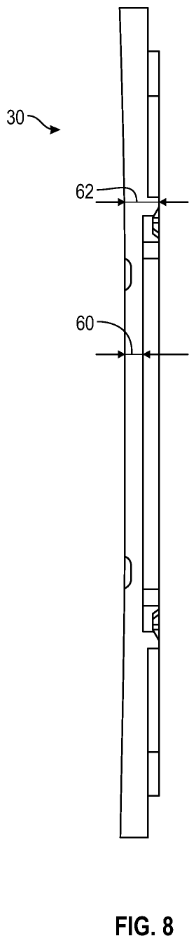

Turning now to FIGS. 5-9, the features of a ground plane 30 according to this disclosure can be better understood. The inner surface 34 of the ground plane has a PCB channel wall 50 defining a center well 52 facing the interior chamber 38 and configured to receive a printed circuit board (PCB). The PCB channel wall 50 is designed to block the flow of liquids traveling along inner surface 34 of ground plane 30 so as to prevent liquid from entering the center well and potentially adversely affecting PCB 42. Typically, PCB channel wall 50 is continuous around center well 52. Additionally, as illustrated, the housing can further comprise a plurality of additional channel walls 54, which along with the PCB channel wall 50 form a plurality of channels 56 on the inner surface to direct flow of liquids along the inner surface 34 of the ground plane 30. Additionally, ground plane 30 can define at least one aperture 64 within center well 52. The aperture 64 extending from the inner surface 34 to the outer surface 32.

As will be realized the thickness of ground plane 30 at the center well 52 and at channels 56 will be less than that at PCB channel wall 50 and additional channel wall 54. For example, ground plane 30 at center well 52 can have a well thickness 60. The wall thickness 62 of ground plane 30 at PCB channel wall 50 and additional channel walls 54 generally will be at least 125%, 150% or 200% of well thickness 60, and generally will be at most 400%, 300% or 250% of well thickness 60. The PCB channel wall 50 and each additional channel wall 54 does not have to have the same wall thickness 62, though they can. Also, while the thickness at the center well 52 will generally be the same or about the same as at channels 56, they can be different but typically each will be in the range relative to the wall thickness indicated above for the well thickness and wall thickness.

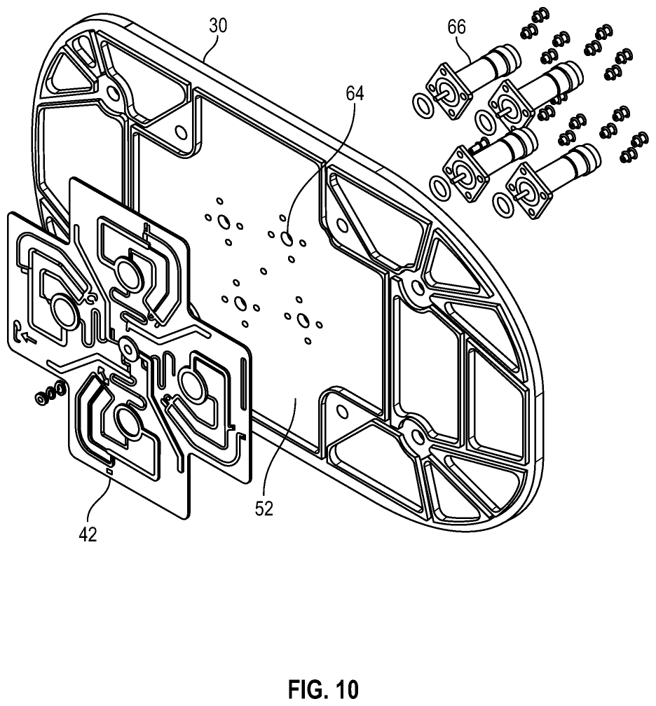

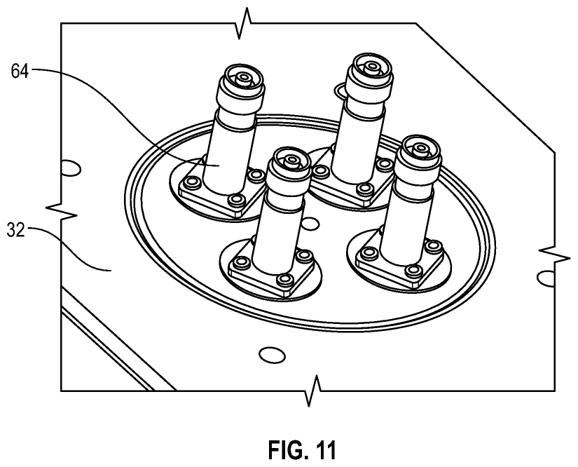

As further illustrated by FIGS. 10 and 11, PCB 42 is mated into center well 52 and is connected to at least one terminal or connector 66. Each such connector 66 can be positioned in a respective aperture 64 so that the connectors can transmit hard-wired signals between the antenna assembly 40 within the housing and outside the housing. More specifically, there are typically a plurality of terminals or connectors 66, which are coupled to the PCB 42 opposite the antenna 44. The connectors 66 pass through apertures 64. Connectors 66 couple with conductors (not shown) in the aircraft to transmit signals between antenna assembly 40 and the aircraft's control systems (not shown).

Therefore, the present systems and methods are well adapted to attain the ends and advantages mentioned, as well as those that are inherent therein. The systems and methods may be modified and practiced in different but equivalent manners apparent to those skilled in the art having the benefit of the teachings herein. Furthermore, no limitations are intended to be the details of construction or design herein shown, other than as described in the claims below. It is therefore evident that the particular illustrative examples disclosed above may be altered or modified, and all such variations are considered within the scope and spirit of the present treatment additives and methods. While the systems and method are described in terms of “comprising,” “containing,” “having,” or “including” various components or steps, the systems and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A traffic collision avoidance system (TCAS) device comprising:
a housing having:
a radome having an interior surface and an exterior surface; and
ground plane having an inner surface and an outer surface, wherein the radome is attached to the ground plane so that the interior surface of the radome and the inner surface of the ground plane form an inner chamber, wherein the inner surface of the ground plane has a PCB channel wall defining a center well facing the inner chamber and configured to receive a printed circuit board (PCB), and wherein the ground plane defines at least one aperture within the center well, the aperture extending from the inner surface to the outer surface;
an antenna assembly contained within the inner chamber of the housing, having at least one antenna, the printed circuit board operatively connected to the antenna; wherein the printed circuit board is positioned in the center well; and
at least one connector positioned within the at least one aperture so that the connectors can transmit hard-wired signals between the antenna assembly within the housing and outside the housing.

2. The TCAS device of claim 1, wherein the PCB channel wall blocks flow of liquids along the inner surface of the ground plane so as to prevent the liquids from entering the center well.

3. The TCAS device of claim 1, wherein the PCB channel wall is continuous around the center well.

4. The TCAS device of claim 1, wherein the ground plane further comprises a plurality of additional channel walls, which along with the PCB channel wall form a plurality of channels on the inner surface to direct flow of liquids along the inner surface of the ground plane.

5. The TCAS device of claim 4, wherein the PCB channel wall is continuous around the center well.

6. The TCAS device of claim 5, wherein the PCB channel wall blocks the flow of the liquids along the inner surface of the ground plane so as to prevent the liquids from entering the center well.

7. A housing for externally-mounted aircraft components, the housing comprising:
a radome having an interior surface and an exterior surface; and
ground plane having an inner surface and an outer surface, wherein the radome is attached to the ground plane so that the interior surface of the radome and the inner surface of the ground plane form an inner chamber, wherein the inner surface of the ground plane has a PCB channel wall defining a center well facing the inner chamber and configured to receive a printed circuit board (PCB).

8. The housing of claim 7, wherein the PCB channel wall blocks flow of liquids along the inner surface of the ground plane so as to prevent the liquids from entering the center well.

9. The housing of claim 7, wherein the PCB channel wall is continuous around the center well.

10. The housing of claim 7, wherein in the ground plane further comprises a plurality of additional channel walls, which along with the PCB channel wall form a plurality of channels on the inner surface to direct flow of the liquids along the inner surface of the ground plane.

11. The housing of claim 10, wherein the PCB channel wall is continuous around the center well.

12. The housing of claim 11, wherein the PCB channel wall blocks the flow of the liquids along the inner surface of the ground plane so as to prevent the liquids from entering the center well.
